(19) United States
(12) Patent Application Publication
(10) Pub. No.: US 2019/0363897 A1
(43) Pub. Date: Nov. 28, 2019

(54) SYSTEM AND METHOD FOR AUTHENTICATING SECURITY CERTIFICATES

(71) Applicant: SICPA HOLDING SA, Rrilly (CH)

(72) Inventor: Pandelis PAPADIMITRIOU, Blonay (CH)

(21) Appl. No.: 16/477,470

(22) PCT Filed: Jan. 5, 2018
(86) PCT No.: PCT/EP2018/050262

§ 371 Date: Jul. 11, 2019

(30) Foreign Application Priority Data
Jan. 11, 2017 (EP) 17151051.4

(51) Int. Cl. H04L 9/32; G06F 21/45; G06F 21/60; H04L 9/00

(52) U.S. Cl. CPC H04L 9/3268; G06F 21/45; H04L 9/3234; G06F 21/602; H04L 9/006; H04L 9/3213

(57) ABSTRACT

The present invention relates to a security item comprising a security certificate comprising data that has been encrypted using a private encryption key. The data is operable to be decrypted using a public decryption key associated with the private encryption key in order to authenticate the security certificate. The present invention also relates to systems and methods for authenticating the security certificate.

### FIELD OF THE INVENTION

The present invention relates generally to a system and method for authenticating security certificates.

### BACKGROUND OF THE INVENTION

It is desirable to securely authenticate certain documents, objects or transactions in order to determine whether or not the document or object is fraudulent, or has been tampered with in an attempt to alter the credentials of the document, object or transaction.

Examples of documents and objects for which secure authentication would be beneficial include identity documents such as: birth certificates, school registration(s), marriage certificates, employment documents, income tax documents, business ownership documents, passport or other travel documents, travel visas and other passport-related entry and exit stamps, death certificates and/or any other proof of validity or certification such as stocks, bounds, international bank drafts etc. Other examples of documents and objects for which secure authentication would be beneficial include artwork, artefacts, manufactured products, memorabilia and/or bills of lading. Examples of transactions for which secure authentication would be beneficial include card, banknote and/or digital transactions.

These documents, objects or transactions may be the target of forgery. Specifically, security certificates used to show the credentials of these documents or objects may be forged in an attempt to convince a third party of the authenticity of the forgery.

There is therefore a need for a new and improved system which would allow for easy and secure authentication of such documents or objects.

### SUMMARY OF THE INVENTION

Accordingly, the preferred embodiments of the present invention provide for an authentication system and method that provides for easy and secure authentication of security certificates.

According to a first aspect of the present invention, there is provided a security certificate comprising data that has been encrypted using a private encryption key, the data being operable to he decrypted using a public decryption key associated with the private encryption key in order to authenticate the security certificate.

The encrypted data may be stored in the form of a visual image. The visual image may be a QR code, a barcode, or a greyscale image. Storing the encrypted data in the form of a visual image allows for visual inspection by an authorised official to determine whether the security certificate noticeably appears to be impermissibly tampered with, thereby increasing the likelihood of detecting tampering or forgeries. It should be noted that visible means in any light condition and not necessarily in visible light conditions.

The encrypted data may alternatively be stored in digital form, such as on a microprocessor chip, a RFID chip, or a magnetic stripe. Storing the encrypted data in a digital form allows for increased durability of the security certificate and also allows for a reduction in the physical space needed to store the data on the security certificate.

The encrypted data may comprise dynamic data. Dynamic data as used herein means data that may be changed and/or updated, for example by user input. The dynamic data may be stored in the form of a stamp, a code or another visual image. Alternatively, the dynamic data may be stored in digital form. The dynamic data may be updated or changed on a central server. In other words, dynamic data associated with a visual image (or dynamic data in digital form) may be stored on a central server, and the dynamic data may be updated and/or changed at any time. The updating and/or changing of the dynamic data may be subject to authorization. Examples of dynamic data include exit and re-entry visa stamps.

The encrypted data may additionally or alternatively comprise static data. Static data as used herein means data that does not change and/or is not updated. As described above with respect to dynamic data, static data may be stored in the form of a visual image or in digital form. Examples of static data include pictures and static fingerprints. Other examples of static data include other types of biometric data, such as iris or facial data.

The security certificate may comprise additional data that has been encrypted using a public encryption key, the data being operable to be decrypted using a private decryption key associated with the public encryption key. Using a public encryption key to encrypt data allows for storage of additional data on the security certificate alongside the data encrypted using a private encryption key. Some or all of the additional data may be encrypted for confidentiality using the public encryption key.

Different public encryption keys may be used to encrypt different parts of the additional data. Use of different public encryption keys to encrypt and authenticate different parts of the additional data allows different parties to access different parts of the additional data. Specifically, different parties may be allowed to access different private decryption keys associated with the different public encryption keys used to encrypt the different parts of the encrypted additional data. Which private decryption keys are accessible by a party may depend on that party's level of authorisation, for example. For example, the additional data may be associated with whether or not a person has overstayed a visa in a particular country. Visibility/accessibility of the data regarding whether or not a person has overstayed could be restricted to travel authorities of some particular, authorised countries, for example. The additional data could alternatively or additionally be related to, for example, eligibility for benefits in a particular country.

The security certificate may form part of a travel visa. Travel visas are an item that would be particularly beneficial for secure authentication using public key encryption, because visas are particularly susceptible to forgery or tampering, and because authentication of travel visas requires co-operation between different countries, which co-operation may be difficult to coordinate in an efficient manner.

The encrypted data may be in the form of a stamp. Using the form of a stamp to display the encrypted data is a versatile method of quickly and efficiently associating encrypted data with a document or object. The stamp may a stamp applied to a travel visa, such as a physical stamp applied by physically stamping or printing onto a page of a passport.

Data may be displayed on the security certificate only in an encrypted visual form, such that no unencrypted data corresponding to the encrypted data may be viewed on the security certificate. By presenting only encrypted data in this manner, no comparison may be made between the encrypted data and unencrypted data, therefore reducing the possibility of tampering with the data that may be made possible due to visual comparison of the encrypted and unencrypted data.

According to a second aspect of the present invention, there is provided a system for authenticating security certificates comprising: a security certificate generator configured to encrypt data using a private encryption key and then generate a security certificate comprising the encrypted data; a public decryption key directory configured to allow an authorised user to access a public decryption key associated with the private encryption key; and an authentication unit configured to decrypt the encrypted data using the accessed public decryption key associated with the private encryption key.

In an embodiment, the authentication unit is configured to determine whether or not the encrypted data has been successfully decrypted using the accessed public decryption key. Automating the process of determining whether or not the encrypted data has been successfully decrypted using the accessed public decryption key allows for faster determination of whether the security certificate is authentic.

In an embodiment, the authentication unit is configured to indicate that the security certificate is authentic if the encrypted data is successfully decrypted. In this way, a determination of whether or not the security certificate is authentic can be achieved. Furthermore, with an automated determination of whether or not the encrypted data has been successfully decrypted, the authentication unit indication as to the authenticity of the security certificate could be cross-checked with a visual check performed by an authorised official to provide redundancy in the authentication process, thereby reducing the possibility of a false positive result.

Similarly, the authentication unit could (additionally or alternatively) be configured to indicate that the security certificate is not authentic if the security certificate is not successfully decrypted, with the same advantages as detailed above.

The authentication unit may additionally or alternatively be configured to apply a checksum algorithm to verify the validity of the decrypted data.

In addition, it is also possible to analyse the security ink used for printing the security certificate, preferably in a first step, to define whether the ink is genuine or not.

In an embodiment, the public decryption key directory may comprise a database containing at least one public decryption key. In an embodiment, the public decryption key directory may comprise a database containing a plurality of public decryption keys. The database may be organised to assign at least one identifier to a public decryption key, the at least one identifier being associated with the associated private encryption key. For example, in the case of travel visas, the public decryption keys may be ordered by issuing country, so that data on a travel visa issued by a particular issuing country is easily identifiable, and a security certificate containing data encrypted with that country's private encryption key may be easily identified to allow the corresponding associated public decryption key to be accessed quickly and efficiently. The database may alternatively be ordered by key function—with keys that are able to encrypt different segments of the data being grouped.

The database may be searchable. The database may be a managed database, wherein a single authorised manager is the sole manager. Alternatively, more than one authorised managers may manage the database.

In an embodiment, the security certificate generator is configured to use a public encryption key to encrypt data when generating the security certificate. Using a public encryption key to encrypt data on the security certificate allows for some or all of the stamp data to be encrypted for confidentiality, as detailed above. Furthermore, the security certificate generator may be configured to use different public encryption keys to provide layers of encryption for different parts of the stamp data, in the same mariner as detailed above.

The system may further comprise a confidential data decryption unit configured to receive, from an authorised user, data encrypted with the public encryption key, the confidential data decryption unit being configured to decrypt the received encrypted data using the associated private decryption key. The private decryption key may be stored on a private decryption key directory configured to allow an authorised user to access the private encryption key associated with the public encryption key. The confidential data decryption unit may then be configured to transmit or otherwise present the decrypted data to the authorised user.

In this manner, the confidential data encrypted using the public encryption key may be decrypted by authorised users without an exchange of private keys between users.

Specifically, the private decryption key directory may be a secure location to allow for central decryption of encrypted confidential data. The private decryption key directory may be a database storing at least one private decryption key. The database may be searchable. The database may be a managed database, wherein an authorised manager is the sole manager. Alternatively, more than one authorised managers may manage the database.

The confidential data decryption unit may be the same or an additional authentication unit. Using an authentication unit also to decrypt confidential data allows for a reduced cost in hardware, and increased security of data-handling.

An authorised user may access the private decryption key by retrieving the private decryption key from the private decryption key directory. The authorised user may decrypt the encrypted confidential data locally, on a confidential data decryption unit, using the retrieved private decryption key.

Besides the possibility to display encrypted and unencrypted data on the security certificate, data may be displayed on the security certificate only in an encrypted visual form, such that no unencrypted data corresponding to the encrypted data may be viewed on the security certificate. By presenting only encrypted data in this manner, no comparison may be made between the encrypted data and unencrypted data, therefore reducing the possibility of tampering with the data that may be made possible due to visual comparison of the encrypted and unencrypted data.

According to a third aspect of the present invention, there is provided a method of authenticating a security certificate comprising: collecting encrypted data stored on the security certificate, the data having been encrypted with a private encryption key; transmitting the encrypted data to an authentication unit for attempted decryption of the encrypted data using a public decryption key associated with the private encryption key; and determining the success or failure of the attempted decryption of the encrypted data, wherein a successful decryption of the encrypted data authenticates the security certificate.

According to a fourth aspect of the present invention, there is provided a method of authenticating a security certificate comprising: collecting encrypted data stored on the security certificate, the data having been encrypted with a private encryption key; retrieving a public decryption key associated with the private encryption key from a public decryption key directory; attempting to decrypt the encrypted data using the public decryption key associated with the private encryption key; and determining the success or failure of the attempted decryption of the encrypted data, wherein a successful decryption of the encrypted data authenticates the security certificate.

Either of the third or fourth aspects may be computer-implemented. The encrypted data may be stored as a visual image or in digital form, as detailed above. The visual image may be a QR code, a barcode, or a greyscale image. The visual image may be a hidden image within an image, or a sequence of frequencies generated through a device such as a key stroke on a digital phone, which frequencies may be generated by a reader or by recorded audio.

In either of the third or fourth aspects, the attempted decryption may be performed by an authentication unit.

The security certificate may form part of a travel visa. As detailed above, these methods are particularly beneficial to travel visas, which are particularly susceptible to forgery, and, because many different participating countries issue travel visas, it is important that information may be shared between participating countries in a secure and efficient manner.

The encrypted data may be displayed in the form of a stamp.

Either of the methods of the third or fourth aspects may be performed multiple times, for example to authenticate encrypted data multiple times at different locations.

In either of the third or fourth aspects, data may be displayed on the security certificate only in an encrypted visual form, such that no unencrypted data corresponding to the encrypted data may be viewed on the security certificate. By presenting only encrypted data in this manner, no comparison may be made between the encrypted data and unencrypted data, therefore reducing the possibility of tampering with the data that may be made possible due to visual comparison of the encrypted and unencrypted data.

In any of the above aspects or embodiments, the transmission of the encrypted data and/or retrieval of a key may be performed using a secure communication channel.

Each of the above aspects or embodiments may be combined with each of the other aspects or embodiments, where applicable.

### BRIEF DESCRIPTION OF THE DRAWINGS

In order to better understand the present invention, to show how the same may be carried into effect, reference will be made, by way of example only, to the following drawings, in which:

FIG. 1 shows a method of generating a security certificate; and

FIG. 2 shows a method of authenticating a security certificate.

### DETAILED DESCRIPTION

The following description illustrates an exemplary embodiment of the disclosed invention in detail. Those skilled in the art will recognise that there are numerous variations and modifications of this invention that are encompassed by the scope of the appended claims. Accordingly, the description of a certain exemplary embodiment should not be deemed to limit the scope of the present invention.

In the following description, the term “access” is a broad term, and, when referring to “accessing a public or private decryption key”, covers both: (1) transmitting encrypted data to a remote authentication unit and then requesting the remote authentication unit to decrypt data using the decryption key; and (2) retrieval of the decryption key to perform local decryption.

In the following description, certain methods are disclosed for encrypting data using public key cryptography.

Public key cryptography utilises pairs of keys: a public key that may be widely accessed and a private key associated with the public key, which private key is known only to the holder of the private key. The public key and private key may be associated in a manner that allows for encryption and/or decryption of data using the corresponding keys, but where it is difficult or impossible to calculate the private key from only the information associated with the public key. For example, the public and private keys may be factors of a product of two large prime numbers. It is computationally very difficult to determine an associated factor of a product of large prime numbers when only knowing one factor and without knowing the prime numbers.

With the associated public and private keys, two different functions may be achieved. Firstly, data may be encrypted using the private key, which data is then decrypted by the public key. This process allows for authentication that the data was encrypted by the owner of the private key. If the encrypted data can therefore be successfully decrypted using the public key, the encrypted data must therefore have been encrypted by the owner of the private key, and is therefore authentic.

Alternatively, encrypting data with a public key means that only the participant with the associated private key can decrypt the data. As such, the data is kept confidential to anyone except a participant with access to the correct associated private key.

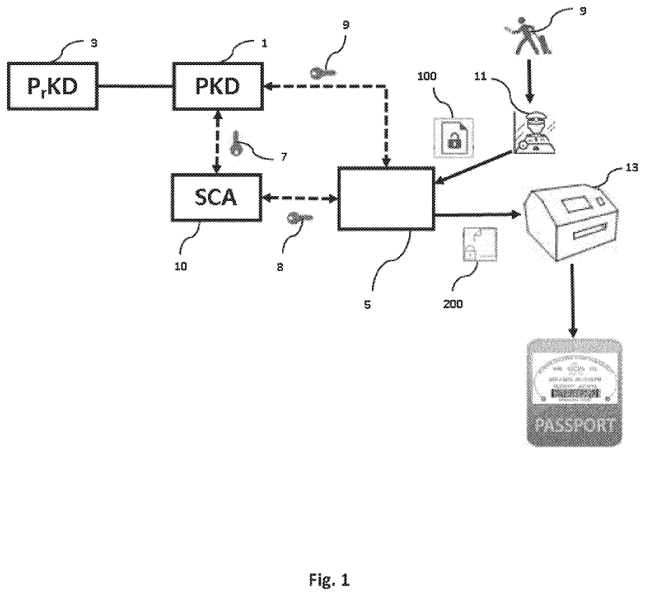

FIG. 1 shows a method for generating a security certificate. Although the particular security certificate illustrated in FIG. 1 is associated with a travel visa for a passport, it will be appreciated that the same technique may be used to generate security certificates for other objects and documents.

In order to generate a security certificate, each authorised user (such as a participating country) has a signing certificate authority (SCA) 10 that generates that participant's private encryption key and associated public decryption key 7. For security reasons, the SCA 10 of each participating country usually securely stores the private encryption key.

As shown in FIG. 1, the signing certificate authority 10 issues the public decryption key 7 to a public decryption key directory (PKD) 1. The public decryption key directory (PKD) 1 may be a database that stores the public keys of each SCA, along with other data: For example the PKD 1 could also store certificate revocation lists and master lists of SCA certificates, which will be described in more detail below.

When data about a specific person or item (for example, the passport of a traveller 9) is required to be issued with a security certificate (such as a travel visa), this data may be collected by an official 11 in an unencrypted form. For a traveller, the unencrypted data 100 may include information regarding passport number, date of entry, time of entry, location of entry such as airport name and gate number, airline flight number associated with the entry, the type of visa granted, entitlement to government benefits, maximum permitted length of stay, biometrics and biographies associated with the passport and/or the traveller, other identifying features of the traveller, passport expiry date, purpose of trip, travel history, interview notes, additional comments by an official, information about the official collecting the data, and/or other information. The official 11 may also verify and validate other information regarding the traveller 9 at this stage, and the verification and validation results may form part of the collected unencrypted data 100.

The unencrypted data 100 may then be entered into a security certificate generator 5. The security certificate generator 5 is configured to encrypt the collected data 100 using the relevant participant's private encryption key 8. The encryption of the data using the participant's private encryption key 8 digitally “signs” the data, to signify the point of origin of the data. The security certificate generator 5 may have a secure communication with the SCA 10 in order to obtain the private encryption key 8. Use of a secure communication channel between the security certificate generator 5 and the SCA 10 allows for easy updating of the private and public keys, which keys are centrally stored. Alternatively, a copy of the private encryption key may be stored on the security certificate generator 5. Further alternatively, the security certificate generator may form a secure communication with the PKD 1 and access a copy 9 of the private encryption key stored on the PKD 1 to encrypt the collected data 100.

The collected unencrypted data 100 may be stored on the PKD 1 or an alternative database or repository in either encrypted or unencrypted form. The stored collected data may be managed by an authorised third party. The stored collected data may be shared between participating countries, or may be analysed for business or security reasons. Access to the stored collected data may be monitored, and may only be granted to authorised users.

Once the unencrypted data 100 is encrypted by the security certificate generator 5, the encrypted data 200 is then incorporated into a security certificate to be associated with the security item. For example, the encrypted data may be printed in the form of a barcode stamp using a stamp printer 13, and then applied to a travel visa in the passport of the traveller 9. Alternatively, the encrypted data may be incorporated in digital form into a magnetic stripe and then applied to a travel visa in the passport of the traveller 9.

Additionally or alternatively, some or all of the collected unencrypted data 10 may be encrypted using a separate public encryption key generated by the SCA. Use of a public encryption key allows for confidentiality of some of the collected data. Such data cannot be decrypted using a public decryption key. Instead, a private decryption key associated with the public encryption key must be used to decrypt this data. Layers of encryption may be used for securing and authenticating different parts of the encrypted data, such as to provide different participants access to different parts of the encrypted data.

For example, in the case of a stamp visa, information in a stamp for a diplomats passport may be differently encrypted than data for a stamp in a general tourist's passport.

The public encryption keys may also be stored locally by the relevant SCA 10 or may be obtained from the PKD 1. Alternatively, the public encryption keys may be stored separately on a private key directory PᵣKD 3, which is accessible in the same manner as the PKD 1.

Any of the collected data 100 may also be uploaded to a master list database stored on the PKD 1. This master list database may be searched and managed by a separate authority.

Data on this master list may be shared between participants, or may be analysed and shared upon specific queries.

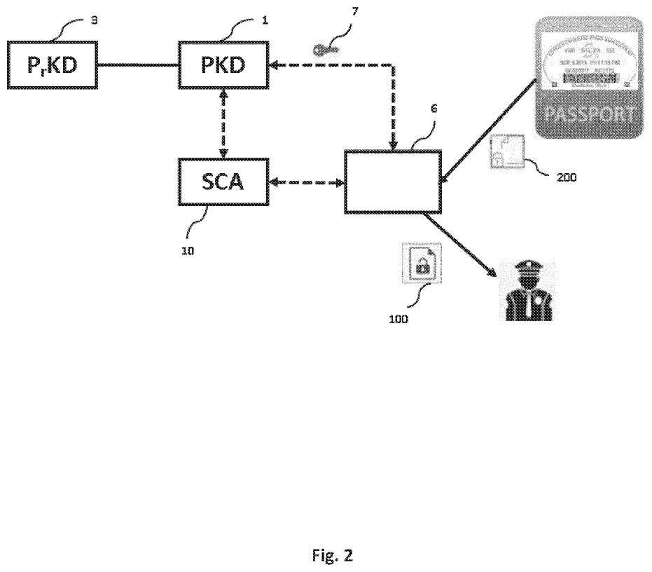

Authentication of the security certificate will now be described with reference to FIG. 2.

To authenticate the security certificate associated with the passport, another official may collect the encrypted data using an authentication unit 6. The authentication unit 6 may collect the encrypted data 200 through various means, such as reading a barcode using a stamp reader, capturing an image of the visual image or a portion of the visual image using an imaging apparatus, retrieving the encrypted data from a memory chip or magnetic stripe, or other methods. The authentication unit may not be local to the official. For example, the official may collect the encrypted data 200 using a stamp reader, and the stamp reader may be configured to transmit the encrypted data 200 to a remote authentication unit 6.

After the encrypted data 200 is collected by or received at the data authentication unit 6, the data authentication unit 6 may determine the origin of the private encryption key used to encrypt the encrypted data 200. This determination of origin may be performed on the basis of some unencrypted data associated with the “digital signing” of the security certificate, such as the issuing country of the travel visa.

After determining the origin of the private encryption key, the data authentication unit 6 may query the PKD 1 to access the associated public decryption key 7. As detailed previously, accessing the associated public decryption key 7 may involve retrieving the public decryption key 7 for local decryption or transmitting the encrypted data 200 to the PKD 1 for remote decryption of the encrypted data 200. These two types of access will now be explained in more detail.

In one embodiment, after receiving a request from an authentication unit 6, the PKD 1 may establish a secure communication channel between itself and the authentication unit in order to securely transfer the public decryption key 7 to the authentication unit 6. The authentication unit 6 then attempts to decrypt the encrypted data 200 using the retrieved public decryption key 7. If the decryption of the encrypted data 200 is successful, the public decryption key must have been correctly associated with the private encryption key 8. As such, it is confirmed that the security certificate is authentic, i.e., the security certificate comprises data that has been encrypted using the expected, correct private encryption key. The authentication unit 6 may indicate the success or failure of the decryption in order to provide an indication as to the authenticity of the security certificate, which may be cross-checked by an official. The authentication unit 6 also displays the unencrypted data 100 to the official.

If the encrypted data 200 has been tampered with after encryption, or if the encrypted data 200 is forged, the public decryption key associated with the private encryption key 8 used by the particular issuing country will not decrypt the encrypted data 200. As such, the data's integrity cannot be ensured, and may be forged or otherwise tempered with. Any change in the data after encryption invalidates the digital signature such that decryption using the associated public decryption key will result in an unintelligible decrypted message.

In another embodiment, the authentication unit may securely transmit the encrypted data 200 to the public key directory 1, and the PKD 1 itself identifies the correct public decryption key to use to decrypt the encrypted data using unencrypted data associated with the security certificate, such as issuing country. The PKD 1 then attempts to decrypt the encrypted data 200 using the selected public decryption key. After attempted decryption, the PKD 1 securely transmits the decrypted data 100, or an indication as to the success or failure of the attempted decryption, to the authentication unit 6. The authentication unit may then indicate the success or failure of the decryption attempt, and display the unencrypted data 100 to the official, for example through the use of an indicator or dedicated software.

The authenticated security certificate may be used to resolve various questions by the official related to a traveller.

In cases where a first participant has encrypted all or part of the data for confidentiality (i.e. some or all of encrypted data 200 has been encrypted using a public, encryption key), the authentication unit may query the PrKD 3 in order to access the private decryption key for decrypting this encrypted data 200, in the same manner as querying for the public decryption key. The PrKD may monitor authorisations associated with various authentication units in order to determine whether the authentication unit 6 is allowed to access the private decryption key. The PrKD may determine whether or not to allow access to a certain private decryption key on the basis of this authorisation.

If a private key becomes compromised, i.e., becomes generally known, updating of the public and private keys may be performed. In this case, the outdated public and/or private keys may be listed on a certificate revocation list stored on the PKD 1, and keys may be cross-checked with this list to add further protection against forgeries.

Further modifications will be apparent to those skilled in the art from a consideration of the disclosure provided herein. Consequently, it is not intended that this invention be limited to the specific embodiments provided herein, but that it covers all modifications and alternatives falling within the spirit and scope of the appended claims.

1. A security item comprising a security certificate comprising data that has been encrypted using a private encryption key, the data being operable to be decrypted using a public decryption key associated with the private encryption key in order to authenticate the security certificate, wherein the security certificate further comprises data that has been encrypted using a public encryption key, the data being operable to be decrypted using a private decryption key associated with the public encryption key.

2. The security item of claim 1, wherein the encrypted data is stored in the form of a visual image.

3. The security item of claim 1, wherein the encrypted data is stored in digital form.

4. The security item of claim 1, wherein the security certificate forms part of a travel visa.

5. A system for authenticating security certificates comprising:
a security certificate generator configured to encrypt data using a private encryption key and then generate a security certificate comprising the encrypted data;
a public decryption key directory configured to allow an authorized user to access a public decryption key associated with the private encryption key; and
an authentication unit configured to decrypt the encrypted data using the accessed public decryption key associated with the private encryption key,
wherein the security certificate generator is further configured to use a public encryption key to encrypt data when generating the security certificate, wherein the system further comprises a confidential data decryption unit configured to receive, from an authorised user, data encrypted with the public encryption key and to decrypt the received data using a private decryption key associated with the public encryption key, the private decryption key being stored on a private decryption key directory configured to allow the authorised user to access the private encryption key associated with the public encryption key.

6. The system of claim 5, wherein the authentication unit is configured to determine whether or not the encrypted data has been successfully decrypted using the accessed public decryption key.

7. The system of claim 6, wherein the authentication unit is configured to indicate that the security certificate is authentic if the encrypted data is successfully decrypted and/or is configured to indicate that the security certificate is not authentic if the security certificate is not successfully decrypted.

8. The system of claim 5, wherein the public decryption key directory comprises a database containing at least one public decryption key.

9. A method of authenticating a security certificate comprising:
collecting encrypted data stored on the security certificate, the encrypted data comprising data that has been encrypted with a private encryption key and data that has been encrypted using a public encryption key;
transmitting the encrypted data to an authentication unit for attempted decryption of the encrypted data using a public decryption key associated with the private encryption key and a private decryption key associated with the public encryption key respectively; and
determining the success or failure of the attempted decryption of the encrypted data, wherein a successful decryption of the encrypted data authenticates the security certificate.

10. The method of claim 9, wherein the method comprises:
retrieving a public decryption key associated with the private encryption key from a public decryption key directory and the private decryption key associated with the public encryption key from a private decryption key directory.

11. The method of claim 9, wherein the encrypted data is stored in the form of a visual image.

12. The method of claim 9, wherein the security certificate forms part of a travel visa.

13. (canceled)

14. (canceled)

15. (canceled)

16. The security item of claim 2, wherein the visual image comprises a QR code, a barcode or a greyscale image.

17. The security item of claim 3, wherein the encrypted data is stored on a microprocessor chip or a magnetic stripe.

18. The method of claim 11, wherein the visual image comprises a QR code, a barcode or a greyscale image.
